(19) United States
(12) Patent Application Publication
(10) Pub. No.: US 2019/0215378 A1
(43) Pub. Date: Jul. 11, 2019

(54) PREDICTING VEHICLE DWELL TIME TO OPTIMIZE V2I COMMUNICATION

(71) Applicant: Cisco Technology, Inc., San Jose, CA (US)

(72) Inventors: Vikram Prasad Munishwar, Santa Clara, CA (US); Avaneesh Anandrao Kadam, San Jose, CA (US); Santosh Ramrao Patil, Santa Clara, CA (US); Durgaprasad Sukhadeo Pawar, Santa Clara, CA (US)

(21) Appl. No.: 15/862,945

(22) Filed: Jan. 5, 2018

(51) Int. Cl. H04L 29/08; H04W 36/32; H04W 4/44; H04W 4/02

(52) U.S. Cl. CPC H04L 67/2847; H04W 36/32; H04L 67/12; H04W 4/027; H04W 4/44

(57) ABSTRACT

In one embodiment, a device identifies a predicted future location of a vehicle. The device uses a machine learning-based model to predict a dwell time for the vehicle at the predicted future location. The device determines, based on the predicted dwell time, whether the vehicle should associate with a wireless access point in the predicted future location. The device selects a particular wireless access point in the predicted future location for association, when the device determines that the vehicle should associate with a wireless access point in the predicted future location. The device initiates an association between the vehicle and the selected wireless access point, prior to the vehicle arriving at the predicted future location.

### TECHNICAL FIELD

The present disclosure relates generally to computer networks, and, more particularly, to the predicting of vehicle dwell time to optimize Vehicle-to-Infrastructure (V2I) communication.

### BACKGROUND

Connected transportation, which is one of the important Internet of Things (IoT) business verticals, focuses on fleet management for vehicles, real time navigation information, and always-on connectivity. Vehicle-to-Infrastructure (V2I) connectivity is an important part of connected transportation and is generally achieved using either cellular or wireless (e.g., Wi-Fi) technology.

While cellular connectivity is prevalent, Wi-Fi hot-spots are also being deployed increasingly by many carriers (e.g., Comcast, AT&T, and the like). Wi-Fi access points (APs) provide “free/low cost” internet connectivity. However, it may be difficult to use wireless APs for V2I connectivity. For example, wireless access generally has a smaller range compared to cellular, which limits the amount of time a vehicle is within Wi-Fi range. Also, comparatively, a significant time is spent for performing authentication and handshaking with Wi-Fi hotspots.

### BRIEF DESCRIPTION OF THE DRAWINGS

The embodiments herein may be better understood by referring to the following description in conjunction with the accompanying drawings in which like reference numerals indicate identically or functionally similar elements, of which:

FIG. 1 illustrates an example communication network;

FIG. 2 illustrates an example network device;

FIGS. 3A-3D illustrate an example vehicle dwell time prediction;

FIGS. 4A-4E illustrate an example wireless access point selection; and

FIG. 5 illustrates an example simplified procedure for associating with a wireless access point selected based on a vehicle dwell time prediction.

### DESCRIPTION OF EXAMPLE EMBODIMENTS

### Overview

According to one or more embodiments of the disclosure, a device identifies a predicted future location of a vehicle. The device uses a machine learning-based model to predict a dwell time for the vehicle at the predicted future location. The device determines, based on the predicted dwell time, whether the vehicle should associate with a wireless access point in the predicted future location. The device selects a particular wireless access point in the predicted future location for association, when the device determines that the vehicle should associate with a wireless access point in the predicted future location. The device initiates an association between the vehicle and the selected wireless access point, prior to the vehicle arriving at the predicted future location.

### DESCRIPTION

A computer network is a geographically distributed collection of nodes interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, or Powerline Communications (PLC), and others. Other types of networks, such as field area networks (FANs), neighborhood area networks (NANs), personal area networks (PANs), etc. may also make up the components of any given computer network.

In various embodiments, computer networks may include an Internet of Things network. Loosely, the term “Internet of Things” or “IoT” (or “Internet of Everything” or “IoE”) refers to uniquely identifiable objects (things) and their virtual representations in a network-based architecture. In particular, the IoT involves the ability to connect more than just computers and communications devices, but rather the ability to connect “objects” in general, such as lights, appliances, vehicles, heating, ventilating, and air-conditioning (HVAC), windows and window shades and blinds, doors, locks, etc. The “Internet of Things” thus generally refers to the interconnection of objects (e.g., smart objects), such as sensors and actuators, over a computer network (e.g., via IP), which may be the public Internet or a private network.

Often, IoT networks operate within a shared-media mesh networks, such as wireless or PLC networks, etc., and are often on what is referred to as Low-Power and Lossy Networks (LLNs), which are a class of network in which both the routers and their interconnect are constrained. That is, LLN devices/routers typically operate with constraints, e.g., processing power, memory, and/or energy (battery), and their interconnects are characterized by, illustratively, high loss rates, low data rates, and/or instability. IoT networks are comprised of anything from a few dozen to thousands or even millions of devices, and support point-to-point traffic (between devices inside the network), point-to-multipoint traffic (from a central control point such as a root node to a subset of devices inside the network), and multipoint-to-point traffic (from devices inside the network towards a central control point).

Fog computing is a distributed approach of cloud implementation that acts as an intermediate layer from local networks (e.g., IoT networks) to the cloud (e.g., centralized and/or shared resources, as will be understood by those skilled in the art). That is, generally, fog computing entails using devices at the network edge to provide application services, including computation, networking, and storage, to the local nodes in the network, in contrast to cloud-based approaches that rely on remote data centers/cloud environments for the services. To this end, a fog node is a functional node that is deployed close to fog endpoints to provide computing, storage, and networking resources and services. Multiple fog nodes organized or configured together form a fog system, to implement a particular solution. Fog nodes and fog systems can have the same or complementary capabilities, in various implementations. That is, each individual fog node does not have to implement the entire spectrum of capabilities. Instead, the fog capabilities may be distributed across multiple fog nodes and systems, which may collaborate to help each other to provide the desired services. In other words, a fog system can include any number of virtualized services and/or data stores that are spread across the distributed fog nodes. This may include a master-slave configuration, publish-subscribe configuration, or peer-to-peer configuration.

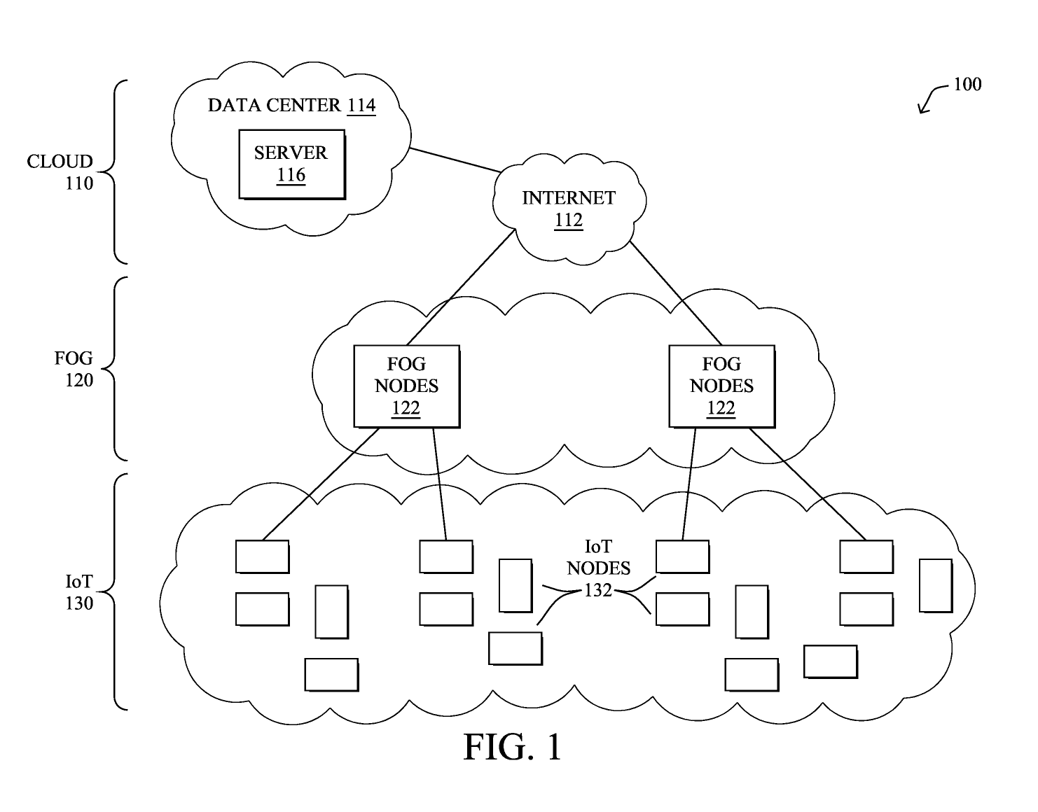

FIG. 1 is a schematic block diagram of an example simplified computer network 100 illustratively comprising nodes/devices at various levels of the network, interconnected by various methods of communication. For instance, the links may be wired links or shared media (e.g., wireless links, PLC links, etc.) where certain nodes, such as, e.g., routers, sensors, computers, etc., may be in communication with other devices, e.g., based on connectivity, distance, signal strength, current operational status, location, etc.

Specifically, as shown in the example network 100, three illustrative layers are shown, namely the cloud 110, fog 120, and IoT device 130. Illustratively, the cloud 110 may comprise general connectivity via the Internet 112, and may contain one or more datacenters 114 with one or more centralized servers 116 or other devices, as will be appreciated by those skilled in the art. Within the fog layer 120, various fog nodes/devices 122 may execute various fog computing resources on network edge devices, as opposed to datacenter/cloud-based servers or on the endpoint nodes 132 themselves of the IoT layer 130. Data packets (e.g., traffic and/or messages sent between the devices/nodes) may be exchanged among the nodes/devices of the computer network 100 using predefined network communication protocols such as certain known wired protocols, wireless protocols, PLC protocols, or other shared-media protocols where appropriate. In this context, a protocol consists of a set of rules defining how the nodes interact with each other.

Those skilled in the art will understand that any number of nodes, devices, links, etc. may be used in the computer network, and that the view shown herein is for simplicity. Also, those skilled in the art will further understand that while the network is shown in a certain orientation, the network 100 is merely an example illustration that is not meant to limit the disclosure.

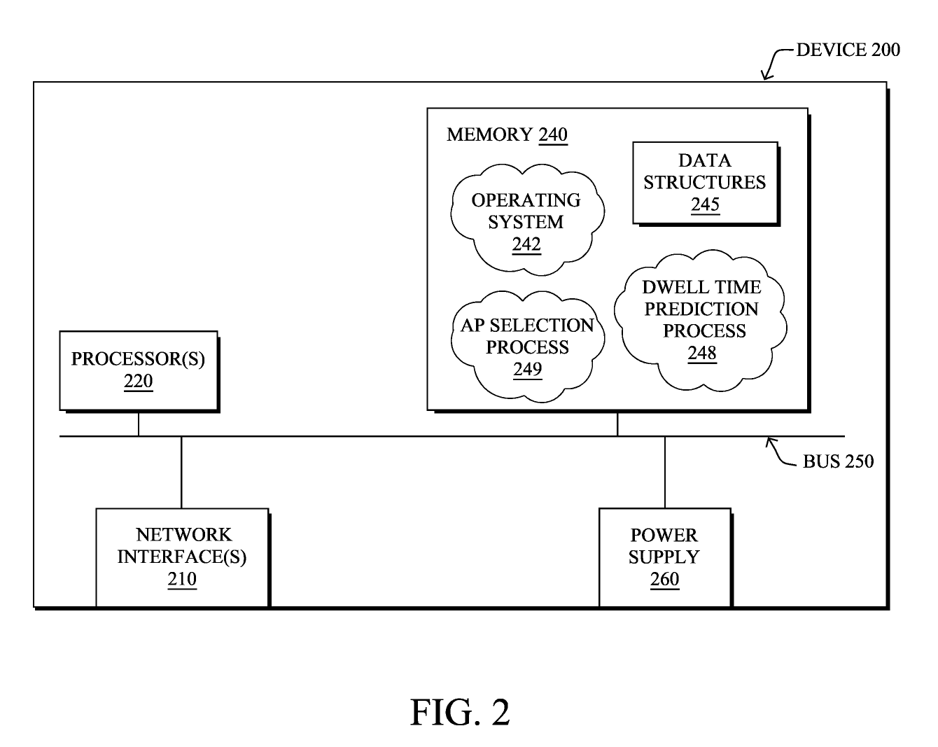

FIG. 2 is a schematic block diagram of an example node/device 200 that may be used with one or more embodiments described herein, e.g., as any of the computing devices shown in FIG. 1, particularly the IoT nodes/sensor(s) 132, fog computing nodes 122 and/or servers 116, or any other computing device that supports the operations of communication network 100 (e.g., routers, access points, switches, etc.), or any of the other devices referenced below. In general, device 200 may include one or more network interfaces 210, one or more processors 220, and a memory 240 interconnected by a system bus 250 and powered by power supply 260.

The network interfaces 210 may include the mechanical, electrical, and signaling circuitry for communicating data over wireless and/or wired links of communication network 100 (e.g., any number of ports, transceivers, antennas, etc.). The network interfaces may be configured to transmit and/or receive data using a variety of different communication protocols. For example, in one embodiment, network interface(s) 210 may include a wireless interface that supports Wi-Fi, cellular, or other wireless technologies to connect device 200, to a nearby Wi-Fi network, 3G/4G cellular data network, or the like. In another embodiment, network interface(s) 210 include an interface for a hardwired network connection such as a 100 Mb/s Power over Ethernet (PoE) port. This not only provides data interconnect, but can also provide the power needed to run the device over the same physical cable, feeding energy into power supply 260. In another embodiment, network interface(s) 210 may include a near-field communication interface that uses Bluetooth or any of the emerging IoT wireless options, to communicatively connect to any other nearby device.

The memory 240 comprises a plurality of storage locations that are addressable by the processor(s) 220 and network interfaces 210 for storing software programs and data structures associated with the embodiments described herein. Note that certain devices may have limited memory or no memory (e.g., no memory for storage other than for programs/processes operating on the device and associated caches). Processor 220 may comprise necessary elements or logic adapted to execute the software programs and manipulate the data structures 245. Operating system 242, portions of which is typically resident in memory 240 and executed by the processor(s), functionally organizes data by, among other things, invoking operations in support of software processors and/or services executing on the device. Illustratively, these software processors and/or services may include dwell time prediction process 248 and access point selection process 249, that are configured to perform the operations as described herein, any of which may alternatively be located within individual network interfaces.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while processes may be shown and/or described separately, those skilled in the art will appreciate that processes may be routines or modules within other processes.

In general, dwell time prediction process 248 includes computer executable instructions that, when executed by processor(s) 220, may be operable to predict the dwell time of a vehicle (e.g., predict future locations where a vehicle will dwell for a greater amount of time), as described in more detail below. In addition, AP selection process 249, when executed, may be operable to choose a wireless access point within the predicted future location with which the vehicle may associate prior to arrival, as described in more detail below. During operation, dwell time prediction process 248 and/or AP selection process 249 may also use cloud computing techniques (e.g., centralized processing from one or more remote servers) or fog computing techniques (e.g., extending the cloud computing paradigm to the edges of the network) to, for example, coordinate activity between the components of each system (e.g., between vehicle sensors and cloud-based sources of information).

As noted above, connected transportation is an important IoT business vertical which focuses on fleet management for vehicles, real time navigation information, and always-on connectivity. Vehicle to Infrastructure (V2I) connectivity, which is an important part of connected transportation, may be achieved using wireless technology. However, it may be difficult to use wireless access points for V2I connectivity since the amount of time a vehicle is within Wi-Fi range may be low while the amount of time spent for performing pre-authentication and pre-handshake with Wi-Fi hotspots is generally high.

To minimize handshake time with Wi-Fi hotspots, the present techniques focus on the dwell time of a vehicle on the road, which is the time during which the vehicle is either stationary or moving slowly. In the dwell time, the vehicle may connect with a Wi-Fi AP and perform a large amount of data download/upload on a free Wi-Fi network for a longer duration than expensive cellular networks. This is crucial in a V2I setting, where users want to maximize their free Wi-Fi usage and minimize their cellular usage for their Internet connection, enabling a connected car to timely download important settings or push critical diagnostic reports in a timely yet cost effective manner.

Dwell time may be correlated with user contextual/behavioral information. For example, the indoor dwell time of a user in a coffee shop may correlate to different activities, such as whether the user purchased a coffee/food to go (less than 2 minutes), for drinking/eating in the shop itself (10-20 mins), or for working (more than 1 hour). The techniques described herein may utilize a similar analysis to predict vehicle dwell time, such as based on analysis of previous behaviors.

Predicting Vehicle Dwell Time to Optimize V2I Communication

The techniques herein predict places where a user (e.g., a moving vehicle) will dwell and for how long, and this information may be used to maximize Wi-Fi usage along the way. Personalized data, such as user behavior, may be combined, in some embodiments, with real-time conditions (e.g. traffic, weather, gas/charge, etc.) in order to predict dwell time en route. Data from onboard vehicle devices, such as sensors and routers, may be utilized to generate unique features for dwell-time prediction, and this information may be leveraged to maximize Wi-Fi usage from vehicle. For example, car sensors and live traffic feeds from satellite may be used to assess the current traffic/car condition for determining a predicted dwell time. This information may be used to perform pre-authorization and/or pre-handshake with the most promising Wi-Fi hotspots in order to maximize Wi-Fi bandwidth utilization in V2I communications.

Specifically, according to one or more embodiments of the disclosure as described in detail below, a device identifies a predicted future location of a vehicle. The device uses a machine learning-based model to predict a dwell time for the vehicle at the predicted future location. The device determines, based on the predicted dwell time, whether the vehicle should associate with a wireless access point in the predicted future location. The device selects a particular wireless access point in the predicted future location for association, when the device determines that the vehicle should associate with a wireless access point in the predicted future location. The device initiates an association between the vehicle and the selected wireless access point, prior to the vehicle arriving at the predicted future location.

Illustratively, the techniques described herein may be performed by hardware, software, and/or firmware, such as in accordance with dwell time prediction process 248 and AP selection process 249, which may include computer executable instructions executed by the processor 220 (or independent processor of interfaces 210) within a V2I environment to perform functions relating to the techniques described herein.

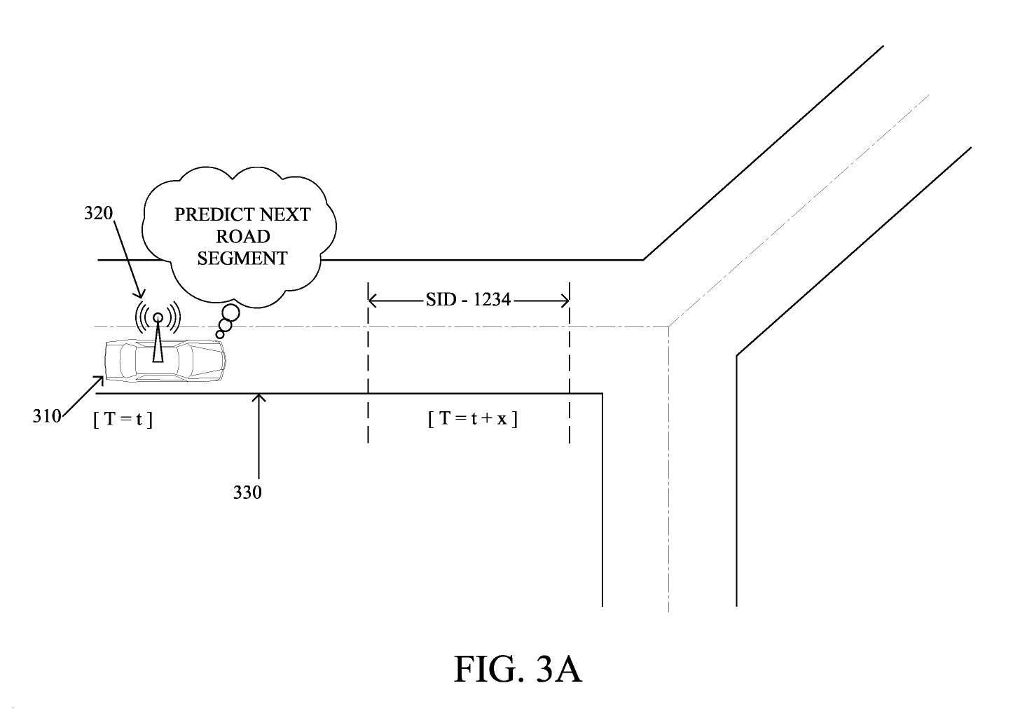

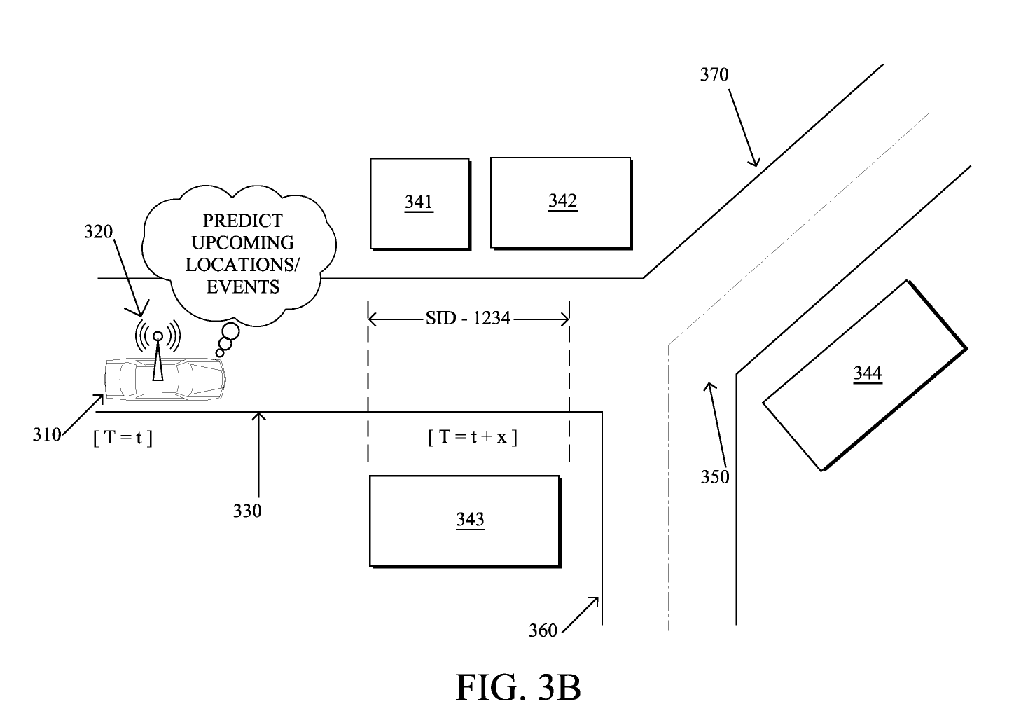

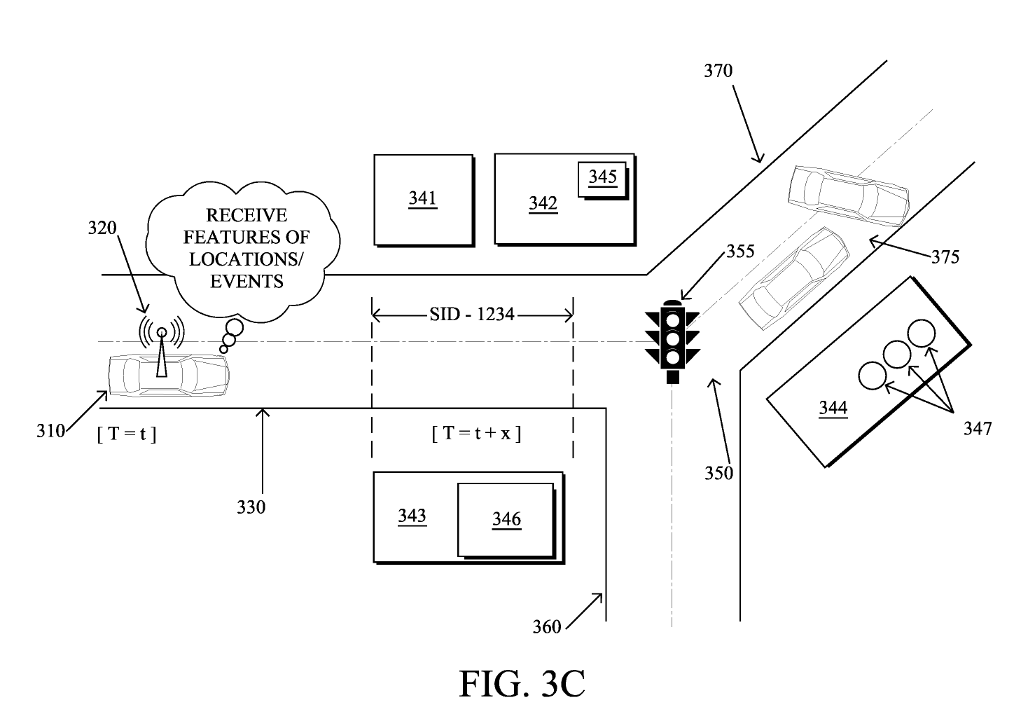

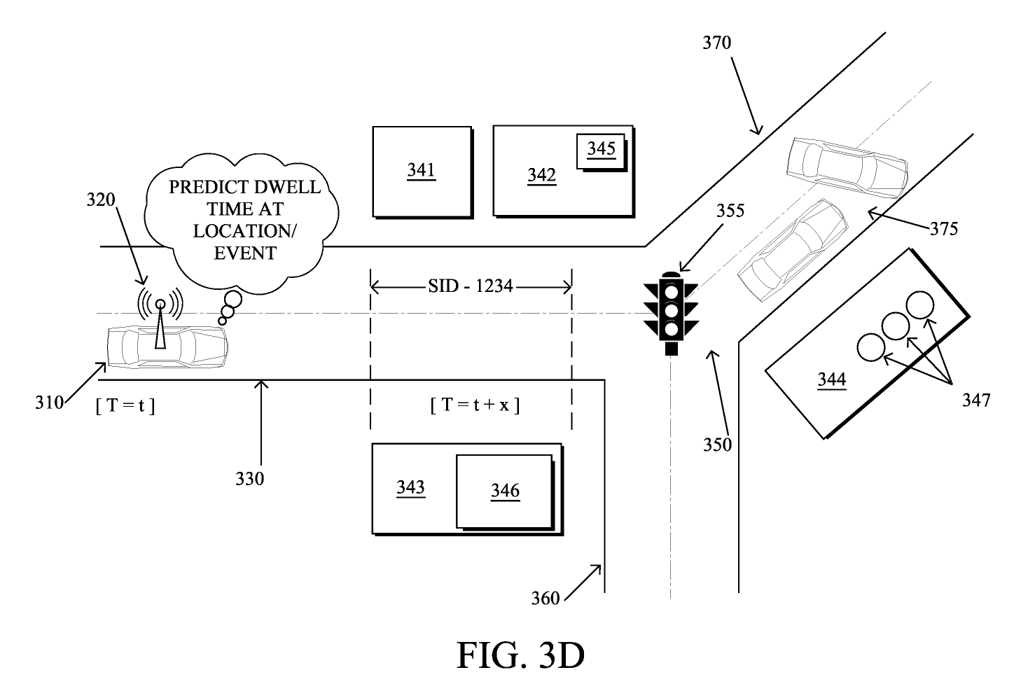

Operationally, FIGS. 3A-3D illustrate various aspects of a vehicle dwell time prediction technique, in accordance with various embodiments. As generally shown, vehicle 310 may be equipped with one or more network connection devices, such as an installed router, a GPS guidance system, etc., to provide V2I connectivity. For example, vehicle 310 may wirelessly connect to external locations through vehicle wireless AP 320.

In some embodiments, the device of vehicle 310 may identify a predicted future location of the vehicle (e.g., a next road segment along which the vehicle will travel, an accessible parking lot, a restaurant or bank drive through, etc.). For example, as shown in FIG. 3A, vehicle 310 may be at a particular location along roadway 330 at a particular time, T=t. The device may predict the next set of road segments on which the vehicle will travel. This may be based, for example, on the current position of the vehicle, the direction of travel, and/or the commute history, which may be stored in the vehicle device (e.g., router). As shown, for example, the device may predict that, at future time T=t+x, vehicle 310 will be at road segment Sid-1234.

The device may predict other or additional future locations of the vehicle, such as upcoming locations/events that may be associated with the predicted next set of road segments. For example, as shown in FIG. 3B, the device may predict that, along road segment Sid-1234, vehicle 310 will be near locations 341-344 (e.g., buildings or specific locations at which the vehicle may stop). The device may also predict that the vehicle will be approaching intersection 350 associated with exit 360 and alternative road 370. Such locations/events may be detected or identified using various available techniques, including, for example, mapping services (GPS), real-time traffic services, vehicle-to-vehicle (V2V) communications (e.g., for providing quick updates to current conditions), car sensors (e.g., on-board camera), V2I communications, etc.

In some embodiments, the device may receive one or more physical features relating to the predicted future locations/events, which may be used to predict vehicle dwell time. The physical features may be specific to the particular location/event characteristics. Features may include location type (e.g., restaurant, shopping mall, bank, refueling station, etc.), available location services (e.g., drive-thru window, store hours, etc.), and traffic or roadway features. For example, as shown in FIG. 3C, the device may identify that locations 341 is a restaurant with only evening hours, that location 342 includes drive-thru 345, location 343 includes parking garage 346, and that location 344 includes refueling stations 347. Also, the device may determine that intersection 350 includes traffic light 355 and that alternative roadway 370 is at least partially blocked by accident 375, which may cause traffic backups. Other physical features may include communication features, such as the availability of network connections (e.g., wireless APs or other Wi-Fi hotspots).

In some embodiments, one or more physical features may be related to the vehicle itself, such as number and identity of occupants and the vehicle status (e.g., age, repair history, fuel reading, tire pressure, etc.). Such features may be important in defining the behavior of vehicle. For example, a single driver may have their own favorite routes or stops, and this may change if there are other people present in the car. Occupant information may be identified by phone MAC ids or by user phone activity (such as check-ins, reservation requests, etc.).

As shown in FIG. 3D, a dwell time for the vehicle at the location/event may be predicted, based, in some embodiments, on the predicted future locations and physical features. As a specific example, dwell time for a vehicle at a traffic light may be predicted based on input from a front camera on the vehicle (e.g., to detect if a traffic light is present and whether it is red or green) and based on real-time traffic feed data to obtain speeds of vehicles ahead. Old wait times from route history may also be used. A prediction may be made whether the vehicle, at its current location, would likely be stopped at the traffic signal and, if so, for how long (e.g., based on data from previous cars traveling the predicted future road segments with their associated wait times and route history data). In a similar way, dwell time at a predicted future location, such as a restaurant, may be based on inputs including location of restaurants near the predicted future road segments, tokens/ads received from the restaurants (e.g., to detect whether the restaurant is a favorite), and route history and previous dwell times (e.g., history of vehicle travels). These may be used to predict if the vehicle will stop at the restaurant and, if so, for how long.

In particular, the device may use machine learning techniques (e.g., a machine learning-based model) to predict vehicle dwell time. In general, machine learning is concerned with the design and the development of techniques that take as input empirical data (such as network statistics and performance indicators), and recognize complex patterns in these data. One very common pattern among machine learning techniques is the use of an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function would be the number of misclassified points. The learning process then operates by adjusting the parameters a, b, and c such that the number of misclassified points is minimal. After this optimization phase (or learning phase), the model M can be used very easily to classify new data points. Often, M is a statistical model, and the cost function is inversely proportional to the likelihood of M, given the input data.

Computational entities that rely on one or more machine learning techniques to perform a task for which they have not been explicitly programmed to perform are typically referred to as learning machines. In particular, learning machines are capable of adjusting their behavior to their environment. For example, a learning machine may dynamically make future predictions based on current or prior network measurements, may make control decisions based on the effects of prior control commands, etc.

For the purposes of predicting dwell time for a vehicle, a learning machine may construct a model of normal behavior to detect data points that deviate from this model. For example, a given model (e.g., a supervised, un-supervised, or semi-supervised model) may be used to generate and report results to another device. Example machine learning techniques that may be used to construct and analyze such a model may include, but are not limited to, nearest neighbor (NN) techniques (e.g., k-NN models, replicator NN models, etc.), statistical techniques (e.g., Bayesian networks, etc.), clustering techniques (e.g., k-means, etc.), neural networks (e.g., reservoir networks, artificial neural networks, etc.), support vector machines (SVMs), or the like.

Clustering may be used as a class of machine learning techniques for the purposes of dwell time predicting. Generally speaking, clustering is a family of techniques that seek to group data according to some typically predefined notion of similarity. For instance, clustering is a very popular technique used in recommender systems for grouping objects that are similar in terms of people's taste (e.g., because you watched X, you may be interested in Y, etc.). Typical clustering algorithms are k-means, density based spatial clustering of applications with noise (DBSCAN) and mean-shift, where a distance to a cluster is computed with the hope of reflecting a degree of anomaly (e.g., using a Euclidian distance and a cluster based local outlier factor that takes into account the cluster density).

Replicator techniques may also be used for purposes of predicting vehicle dwell time. Such techniques generally attempt to replicate an input in an unsupervised manner by projecting the data into a smaller space (e.g., compressing the space, thus performing some dimensionality reduction) and then reconstructing the original input, with the objective of keeping the “normal” pattern in the low dimensional space. Example techniques that fall into this category include principal component analysis (PCA) (e.g., for linear models), multi-layer perceptron (MLP) ANNs (e.g., for non-linear models), and replicating reservoir networks (e.g., for non-linear models, typically for time series).

In some embodiments, a machine learning based model may be used to predict the dwell time of a vehicle at a predicted future location (e.g., road segment Sid-1234). In particular, the device may use a machine learning algorithm that takes vehicle driving history and one or more physical features of the predicted future locations as inputs and predicts dwell times for the next predicted road segment. For example, vehicle commute history, including duration spent on each road segment, may be available and stored at the device (e.g., a vehicle router). Additional physical feature inputs include any of those described above, such as the presence of a traffic light, exit/turn, or traffic jams or the specific characteristics of a location/building (e.g., whether it is a favorite often-visited restaurant or refueling station).

Machine learning technique, such as a multi-class classification algorithm, may be employed to classify each predicted future location/event into one of several defined groups, each corresponding to a coarse notion of expected dwell time. In particular, a prediction algorithm may be applied for a future predicted road segment in which a plurality of dwell time classifications associate different ranges of dwell times. For example, a first class may include dwell times of 1-10 seconds, a second class may be dwell times of 10-30 seconds, a third class may be dwell times of 30-60 seconds, and a fourth and fifth class may include dwell times of 1-2 minutes or greater than 2 minutes respectively. Other classification schemes may also be used.

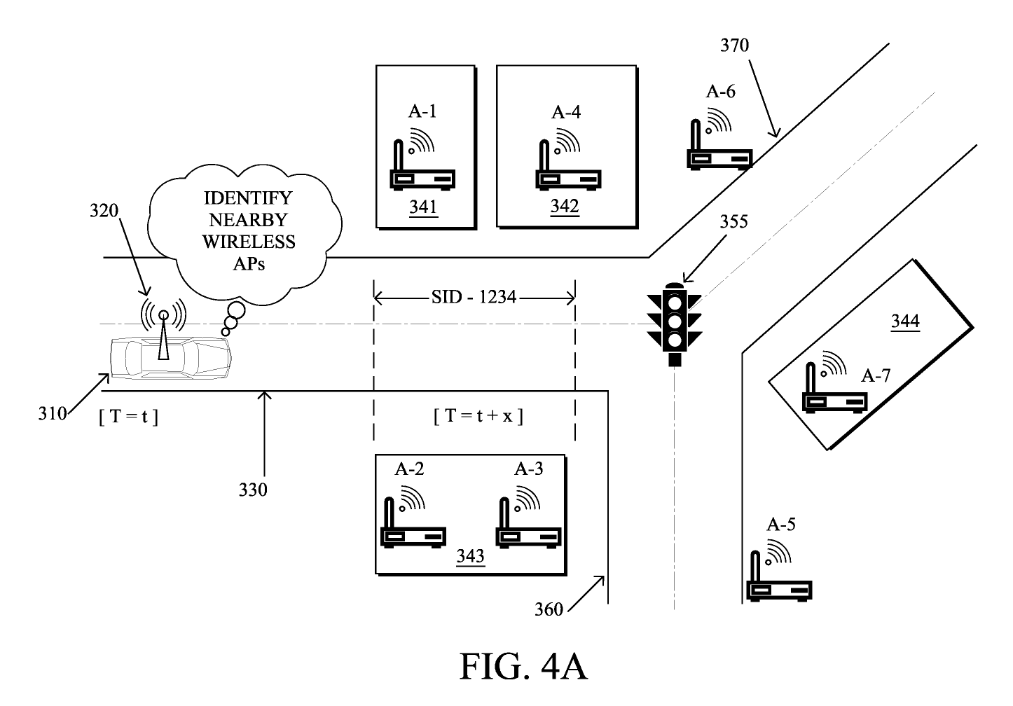

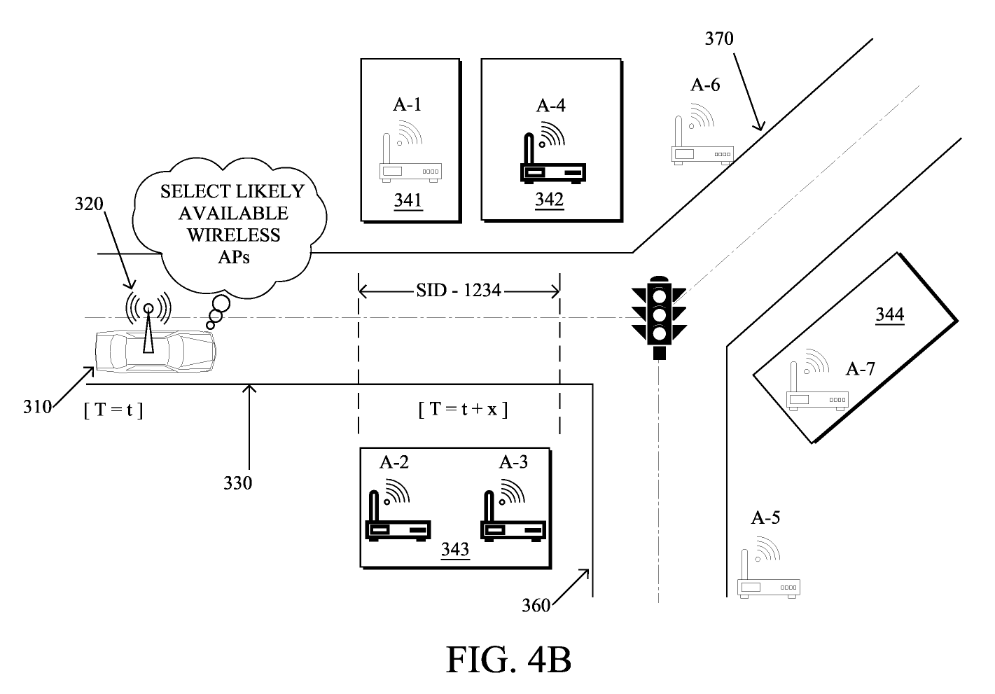

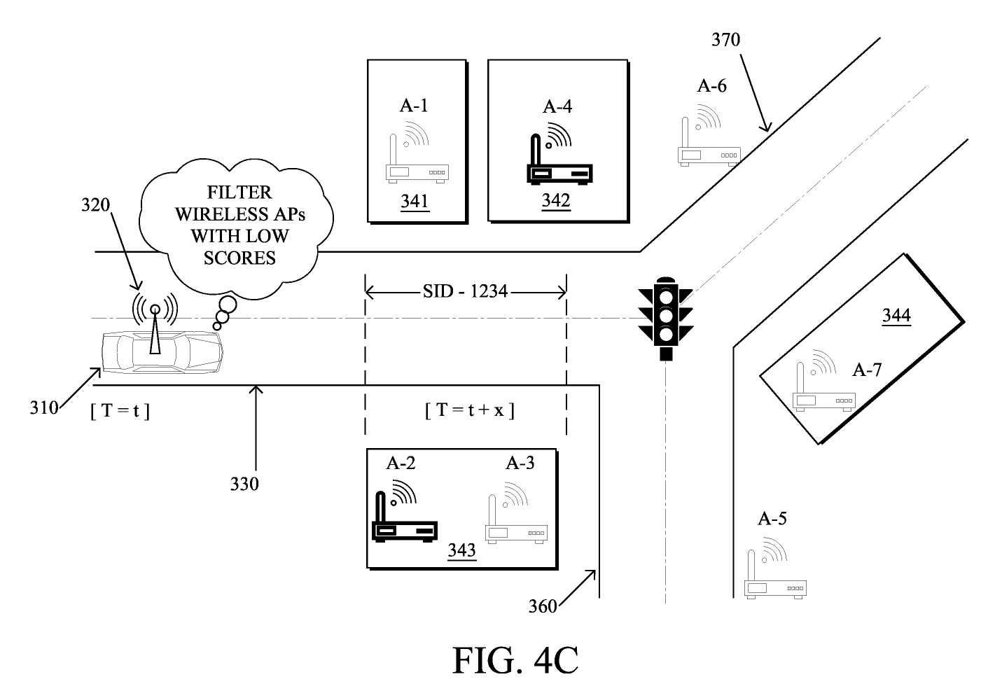

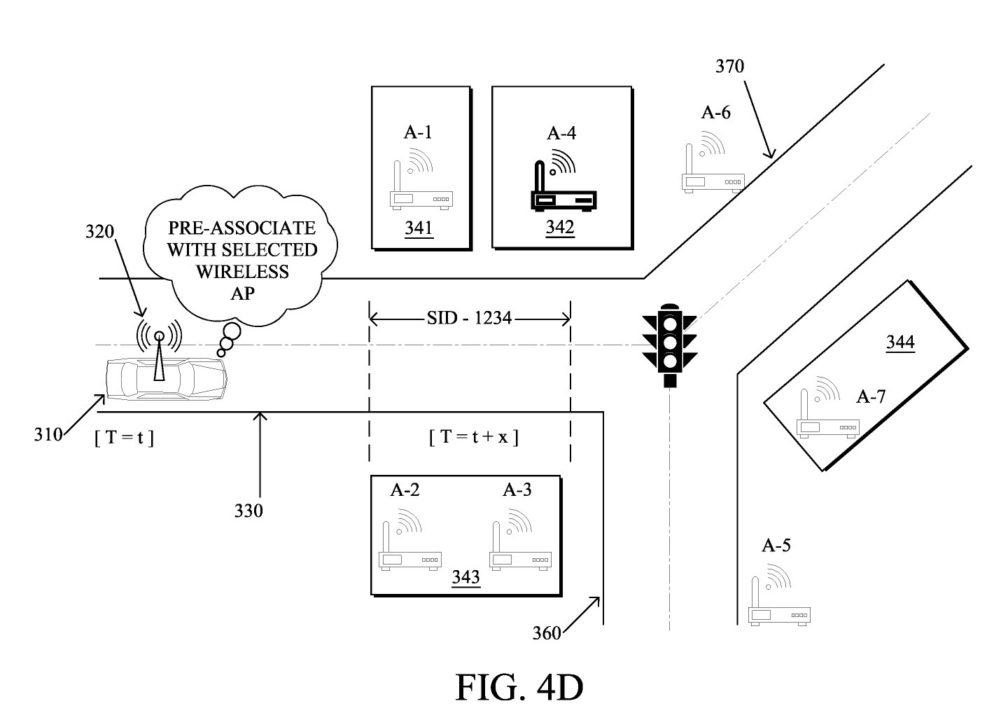

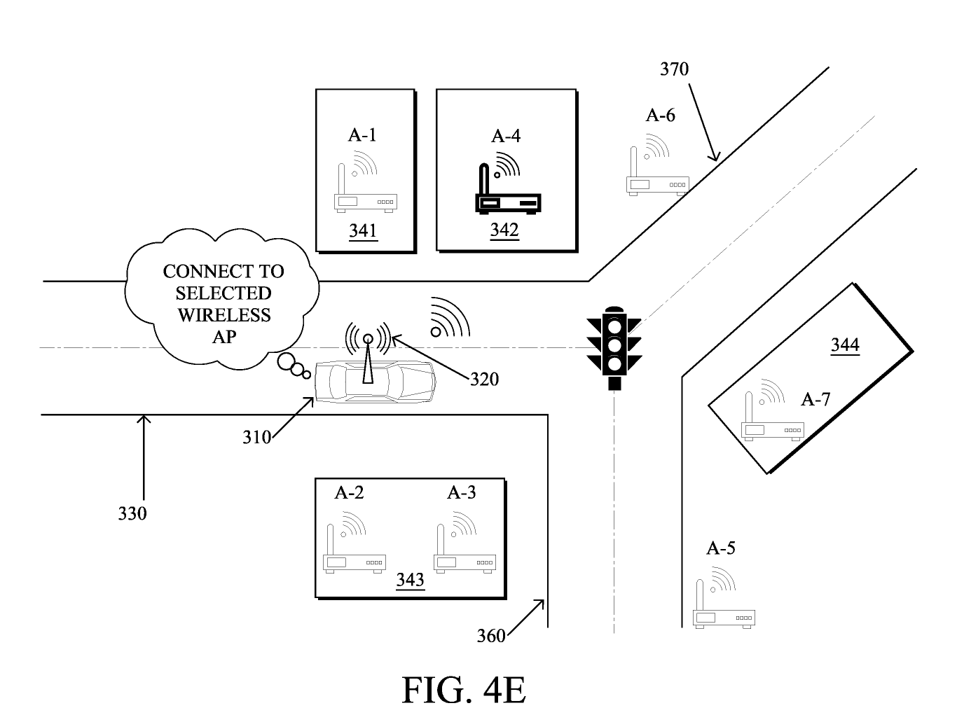

FIGS. 4A-4E illustrate various aspects of an access point selection technique, in accordance with various embodiments. As generally shown, based on the predicted dwell time, a determination may be made of whether the vehicle should associate with a wireless AP and, if so, which wireless AP to choose. One or more APs (e.g., a Wi-Fi hotspot) may be selected with which the vehicle can pre-authenticate and/or pre-handshake, prior to the vehicle arriving at the predicted future location, in order to reduce the Wi-Fi association time.

As shown in FIG. 4A, a device of vehicle 310 (e.g., a router) may identify nearby wireless APs that may be available for association at various predicted locations, depending on the predicted dwell time of the vehicle. For example, wireless APs A-1 through A-7 may be identified near to predicted road segment Sid-1234 (e.g., location 341 may include wireless AP A-1 while location 343 may include wireless APs A-2 and A-3). Various techniques may be used to identify nearby access points. In particular, a geolocation mapping database may be accessed to determine which wireless access points serve the area in the vicinity of the predicted location/event.

While various wireless access points may be determined to be present, not all of them may be available for association, particularly based on the predicted vehicle dwell time. Therefore, as shown in FIG. 4B, in some embodiments, wireless APs that are likely to be available may be selected by the vehicle device, prior to reaching the predicted future location/event. In particular, in some embodiments, information may be queried from each of nearby APs (required network APIs are assumed), including current load of the wireless access points (e.g., the number of associated clients), supported technologies or communication protocols (e.g., whether multiple in, multiple out (MIMO) is supported), transmit power levels, which impact the range of the access point, and radio frequency (RF) signal characteristic data (e.g., operating frequencies, channel utilization, etc.). In a specific example shown in FIG. 4B, prior to vehicle 310 entering predicted future road segment Sid-1234 and based on the predicted dwell time value, wireless APs A-2, A-3, and A-4] may be selected as likely to serve the area and may be candidates for association.

Based on this information, in some embodiments, a score may be assigned to each nearby wireless AP. The score, which reflects suitability of the AP serving the area, may be used to filter the nearby APs. Access points with a score greater than a threshold value may be returned to the device as potential choices with which to perform final association while those with values below the threshold are no longer considered. As shown in the specific example in FIG. 3C, wireless AP A-3 may be filtered out, due to a low assigned score. The remaining APs (A-2 and A-4) are therefore available as candidates for potential association. In some embodiments, these wireless APs may be provided to a user, such as through a user interface. Selection of a particular wireless access point may be made by the user via the interface, which may be received at the device for association.

In some embodiments, association with the selected wireless access point may be initiated by the vehicle device prior to the vehicle entering the predicted location/event area. Such a pre-association may be performed using the vehicle's current network. For example, as shown in FIG. 4D, vehicle 310 may pre-associate with selected wireless AP A-4. By pre-authenticating (prior to the vehicle arriving at the predicted future location), Wi-Fi association time can be significantly reduced. In this way, upon connection to the selected AP as shown in FIG. 4E, wireless usage may be maximized, which is generally at lower cost to the user.

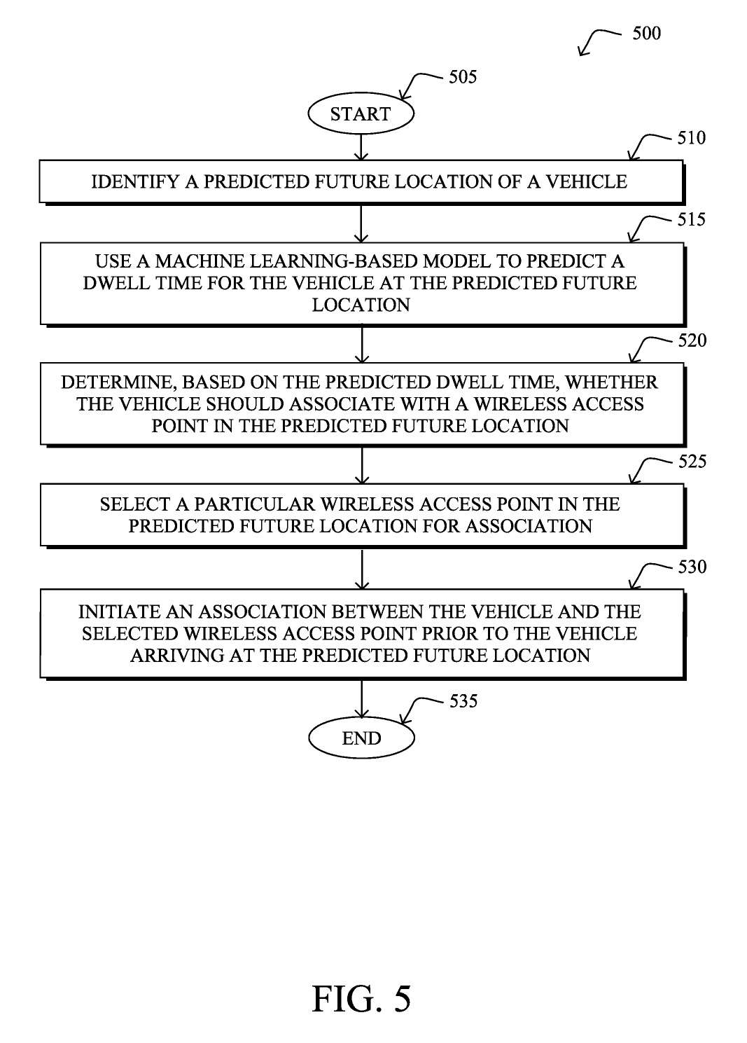

FIG. 5 illustrates an example simplified procedure for predicting vehicle dwell time to optimize V2I communication, in accordance with one or more embodiments described herein. For example, a non-generic, specifically configured device (e.g., device 200) may perform procedure 500 by executing stored instructions (e.g., dwell time prediction process 248 and AP selection process 249).

The procedure 500 may start at step 505, and continues to step 510, where, as described in greater detail above, a device identifies a predicted future location of a vehicle. In some embodiments, the predicted future location may be a particular road segment on which the vehicle may be anticipated to travel from its current position. The predicted future location may also be one or more upcoming locations/events that may be associated with the predicted road segment. Physical features relating to characteristics of the predicted future locations/events may also be received by the device, including, for example, a traffic signal, a refueling station, or a drive-thru. In some embodiments, the device may be a network connection device, such as a router, equipped with the vehicle.

At step 515, as described in greater detail above, the device uses a machine learning-based model to predict a dwell time for the vehicle at the predicted future location. In some embodiments, the device may use vehicle driving history and one or more of the physical features relating to the prediction future location as input to the machine learning-based model. The model may predict the vehicle dwell time by assigning the vehicle to one of a plurality of dwell time classifications that are associated with different dwell time ranges (e.g., duration ranges).

At step 520, as described in greater detail above, the device determines, based on the predicted dwell time, whether the vehicle should associate with a wireless access point in the predicted future location. Such a determination, in some embodiments, may comprise identifying wireless access points that near to the predict locations/events (e.g., near to the predicted road segment) prior to the vehicle arriving. Techniques such as geolocation mapping may be used to identify potential wireless access points with which the device may associate.

At step 525, as described in greater detail above, the device selects a particular wireless access point in the predicted future location for association. In particular, when the device determines that the vehicle should associate with a wireless access point in the predicted future location, a particular device may be selected from among those identified as likely to be available. In some embodiments, a score may be assigned by the device to the potential wireless access points, based, for example, on their current loads, radio frequency (RF) signal strength or reliability, or supported communication protocols. Access points having a score below a threshold value may be filtered out while those having a score greater than the threshold may be presented to a user through a user interface for selection.

At step 530, as described in greater detail above, the device initiates an association between the vehicle and the selected wireless access point. Such an association may occur prior to the vehicle arriving at the predicted future location. In some embodiments, the device may pre-authenticate the vehicle to the selected wireless access point. By performing association and authentication ahead of the vehicle arriving at the predicted future location, wireless access usage may be maximized. Procedure 500 then ends at step 535.

It should be noted that while certain steps within procedure 500 may be optional as described above, the steps shown in FIG. 5 are merely examples for illustration, and certain other steps may be included or excluded as desired. Further, while a particular order of the steps is shown, this ordering is merely illustrative, and any suitable arrangement of the steps may be utilized without departing from the scope of the embodiments herein. In addition, the steps within procedure 500 may be repeated any number of times, in some embodiments, such as part of an iterative process that leverages machine learning to predict vehicle dwell time to optimize V2I communication.

The techniques described herein, therefore, provide predictions of dwell times for vehicles by combining next location/event information with vehicle behavioral data, particularly as a function of all passengers in the vehicle. The techniques may utilize data from an in-vehicle device (e.g., a router), on-board sensors (e.g., cameras), global traffic systems, as well as information on passengers to predict a dwell time for a vehicle at a predicted future location and to use this information to select the best available wireless access point along each road segment for pre-authorization/pre-handshaking, thereby minimizing association time with the access point and maximizing Wi-Fi usage.

While there have been shown and described illustrative embodiments that provide for predicting vehicle dwell time for optimizing V2I communication, it is to be understood that various other adaptations and modifications may be made within the spirit and scope of the embodiments herein.

The foregoing description has been directed to specific embodiments. It will be apparent, however, that other variations and modifications may be made to the described embodiments, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly this description is to be taken only by way of example and not to otherwise limit the scope of the embodiments herein. Therefore, it is the object of the appended claims to cover all such variations and modifications as come within the true spirit and scope of the embodiments herein.

What is claimed is:

1. A method comprising:
identifying, by a device, a predicted future location of a vehicle;
using, by the device, a machine learning-based model to predict a dwell time for the vehicle at the predicted future location;
determining, by the device and based on the predicted dwell time, whether the vehicle should associate with a wireless access point in the predicted future location;
selecting, by the device, a particular wireless access point in the predicted future location for association, when the device determines that the vehicle should associate with a wireless access point in the predicted future location; and
initiating, by the device, an association between the vehicle and the selected wireless access point, prior to the vehicle arriving at the predicted future location.

2. The method as in claim 1, wherein the selected wireless access point comprises a Wi-Fi hotspot, and wherein the device comprises a router for the vehicle.

3. The method as in claim 1, wherein selecting the particular wireless access point in the predicted future location for association comprises:
providing, by the device, one or more wireless access points in the predicted future location to a user interface; and
receiving, at the device, a selection of the particular wireless access point via the user interface.

4. The method as in claim 1, wherein selecting the particular wireless access point in the predicted future location for association comprises:
assigning, by the device, scores to the wireless access points in the predicted future location based on one or more of: current loads of the wireless access points, radio frequency (RF) signal characteristics of the wireless access points, or supported communication protocols of the wireless access points.

5. The method as in claim 1, wherein initiating the association between the vehicle and the selected wireless access point, prior to the vehicle arriving at the predicted future location, comprises:
performing, by the device, authentication of the vehicle to the selected wireless access point, prior to the vehicle arriving at the predicted future location.

6. The method as in claim 1, wherein using the machine learning-based model to predict the dwell time for the vehicle at the predicted future location comprises:
using, by the device, a driving history of the vehicle and one or more physical features of the predicted future location as input to the machine learning-based model.

7. The method as in claim 6, wherein the one or more physical features of the predicted future location comprises at least one of: a traffic signal, a refueling station, or a drive-thru.

8. The method as in claim 1, wherein using the machine learning-based model to predict the dwell time for the vehicle at the predicted future location comprises:
assigning, by the device, the vehicle to one of a plurality of dwell time classifications, wherein each dwell time classification is associated with a different range of dwell times.

9. The method as in claim 1, wherein identifying the predicted future location of the vehicle comprises:
assessing, by the device, a current location of the vehicle using a history of travel of the vehicle.

10. An apparatus, comprising:
one or more network interfaces to communicate with a network;
a processor coupled to the network interfaces and configured to execute one or more processes; and
a memory configured to store a process executable by the processor, the process when executed configured to:
identify a predicted future location of a vehicle;
use a machine learning-based model to predict a dwell time for the vehicle at the predicted future location;
determine, based on the predicted dwell time, whether the vehicle should associate with a wireless access point in the predicted future location;
select a particular wireless access point in the predicted future location for association, when the device determines that the vehicle should associate with a wireless access point in the predicted future location; and
initiate an association between the vehicle and the selected wireless access point, prior to the vehicle arriving at the predicted future location.

11. The apparatus as in claim 10, wherein the selected wireless access point comprises a Wi-Fi hotspot, and wherein the device comprises a router for the vehicle.

12. The apparatus as in claim 10, wherein the apparatus selects the particular wireless access point in the predicted future location for association by:
providing one or more wireless access points in the predicted future location to a user interface; and
receiving a selection of the particular wireless access point via the user interface.

13. The apparatus as in claim 10, wherein the apparatus selects the particular wireless access point in the predicted future location for association by:
assigning scores to the wireless access points in the predicted future location based on one or more of: current loads of the wireless access points, radio frequency (RF) signal characteristics of the wireless access points, or supported communication protocols of the wireless access points.

14. The apparatus as in claim 10, wherein the apparatus initiates the association between the vehicle and the selected wireless access point, prior to the vehicle arriving at the predicted future location, by:
performing authentication of the vehicle to the selected wireless access point, prior to the vehicle arriving at the predicted future location.

15. The apparatus as in claim 10, wherein the apparatus uses the machine learning-based model to predict the dwell time for the vehicle at the predicted future location by:
using a driving history of the vehicle and one or more physical features of the predicted future location as input to the machine learning-based model.

16. The method as in claim 15, wherein the one or more physical features of the predicted future location comprises at least one of: a traffic signal, a refueling station, or a drive-thru.

17. The apparatus as in claim 10, wherein the apparatus uses the machine learning-based model to predict the dwell time for the vehicle at the predicted future location by:
assigning the vehicle to one of a plurality of dwell time classifications, wherein each dwell time classification is associated with a different range of dwell times.

18. The apparatus as in claim 17, wherein the machine learning-based model comprises multi-class classifier.

19. The apparatus as in claim 10, where the apparatus identifies the predicted future location of the vehicle by:
assessing a current location of the vehicle using a history of travel of the vehicle.

20. A tangible, non-transitory, computer-readable medium storing program instructions that cause a device to execute a process comprising:
identifying, by the device, a predicted future location of a vehicle;
using, by the device, a machine learning-based model to predict a dwell time for the vehicle at the predicted future location;
determining, by the device and based on the predicted dwell time, whether the vehicle should associate with a wireless access point in the predicted future location;
selecting, by the device, a particular wireless access point in the predicted future location for association, when the device determines that the vehicle should associate with a wireless access point in the predicted future location; and
initiating, by the device, an association between the vehicle and the selected wireless access point, prior to the vehicle arriving at the predicted future location
